(19) United States
(12) Patent Application Publication
(10) Pub. No.: US 2009/0232059 A1
(43) Pub. Date: Sep. 17, 2009

(54) Latency Reduction When Setting Up An Uplink Wireless Communications Channel

(75) Inventors: Krister Sundberg, Sollentuna (SE); Benny Lennartson, Hagersten (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/721,405

(22) PCT Filed: Dec. 13, 2004
(86) PCT No.: PCT/SE2004/001862

§ 371 Date: Jun. 11, 2007

(51) Int. Cl. H04W 76/00

(52) U.S. Cl. 370/329

(57) ABSTRACT

The present invention relates to wireless communications. More especially it relates to wireless packet data communications. Particularly it relates to latency reduction responding <<ReStart>> to downlink data when received <<SpStop>>.

### TECHNICAL FIELD OF THE INVENTION

The present invention relates to wireless communications. More especially it relates to wireless packet data communications. Particularly it relates to latency reduction when setting up an uplink communications channel.

### BACKGROUND AND DESCRIPTION OF RELATED ART

Multiplexing of a plurality of users on a common resource is well known in prior art. FDM (Frequency Division Multiplex), TDM (Time Division Multiplex) and CDM (Code Division Multiplex) are well known examples of multiplexing principles.

Also a number of queuing disciplines are known for scheduling traffic on the multiplexed resource.

Kenth Fredholm, Kristian Nilsson, ‘Implementing an application for communication and quality measurements over UMTS networks,’ LiTH-ISY-EX-3369-2003, Linköping 2003, describes simulations of voice over IP (Internet Protocol) in a UMTS (Universal Mobile Telecommunications System) system. The master thesis includes concepts such as QoS (Quality of Service), AMR (Adaptive Multi Rate), RTP (Real-time Transport Protocol), RTCP (Real-time Transport Control Protocol) and SIP (Session Initiation Protocol).

AMR can operate at various bit rates including, e.g., 12.2 and 4.75 kbit/s. Background noise is produced at 1.8 kbit/s. An AMR frame comprises an AMR header, AMR auxiliary information and an AMR core frame.
The AMR header comprises
   frame type, and
   frame quality indicator.
The AMR auxiliary information comprises
   mode indication,
   mode request, and
   CRC parity bits.
The AMR core frame comprises comfort noise data or speech data divided into three classes of data bits,
   Class A,
   Class B, and
   Class C.

Comfort noise is transmitted in Class A bit field. Speech data classified in Class A bits are bits considered most important and Class C bits least for a resulting (decoded) speech quality. In UMTS, SCR (Source Controlled Rate) operation is mandatory for AMR and controls transmission data rate.

RTP supports various lower level protocols but typically runs over UDP (User Datagram Protocol) as illustrated in FIG. 1. Both RTP and UDP are generally referred to as protocols of transport layer in a protocol stack as that in FIG. 1. AMR frames of a multimedia application, in the application layer, are sent in RTP packets. FIG. 3.2 in the master thesis illustrates an overview of initiation of an end-to-end communications session between two AMR enabled phones over a UMTS network.

Hossam Fattah, Cyril Leung, ‘An Overview of Scheduling Algorithms in Wireless Multimedia Networks, ’ IEEE Wireless Communications, pp. 76-83, June 2002 describes a plurality of scheduling algorithms and among other things scheduling in CDMA networks. One algorithm, Scheduled CDMA, reveals data exchange between BS and MS in fixed-size unit called capsule, comprising one or more packets. For uplink scheduling, a capsule transmission request is sent to base station by mobile station whenever the MS has new packets to transmit. For each time slot the scheduler selects capsule transmission requests from a common queue ordered according to priority or delay sensitivity. The base station sends transmission permission capsules to selected mobile stations to inform them of their capsule transmission times and power levels.

3^{rd} Generation Partnership Project (3GPP): Technical Specification Group Core Network, Mobile radio interface layer 3 specification, (Release 1998), 3GPP TS 04.08 v7.21.0, France, December 2003, specifies procedures for Radio Link Control, RLC, and specifies the procedures used at the radio interface for Call Control, CC, Mobility Management, MM, Radio Resource, RR, management and Session Management, SM. Paragraph 3.5.2.1.2 describes initiation of packet access procedure and channel request. A mobile station initiates a packet access procedure by scheduling sending of CHANNEL REQUEST messages on RACH and leaving the packet idle mode. The RR entity of the mobile station schedules CHANNEL REQUEST messages on RACH.

3^{rd} Generation Partnership Project (3GPP): Technical Specification Group GSM/EDGE Radio Access Network, General Packet Radio Service (GPRS), Mobile Station (MS)—Base Station System (BSS) interface, Radio Link Control/Medium Access Control (RLC/MAC) protocol, (Release 1999), 3GPP TS 04.60 v7.21.0, France, December 2003, specifies the procedures used at the radio interface (Reference Point Um) for the General Packet Radio Service, GPRS, Medium Access Control/Radio Link Control, MAC/RLC, layer. The present document provides the overall description for RLC/MAC layer functions of GPRS and EGPRS (General Packet Radio Service and Enhanced General Packet Radio Service) radio interface Um. Within this TS the term GPRS refers to GPRS and EGPRS unless explicitly stated otherwise. Paragraph 7.1.2.1.1 relates to access persistence control on PRACH. The PRACH Control Parameters IE contains the access persistence control parameters and shall be broadcast on PBCCH (Packet Broadcast Control Channel) and PCCCH (Packet Common Control Channel). The parameters included in the PRACH Control Parameters IE are:
MAX_RETRANS, for each radio priority i (i=1, 2, 3, 4);
PERSISTENCE_LEVEL, which consists of the PERSISTENCE_LEVEL P(i) for each radio priority i (i=1, 2, 3, 4), where P(i)ε{0, 1, . . . 14, 16}. If the PRACH Control Parameters IE does not contain the PERSISTENCE_LEVEL parameter, this shall be interpreted as if P(i)=0 for all radio priorities;
S used to determine next TDMA frame; and
TX_INT, the value, T, of which is used to determine next TDMA frame.

The mobile station shall make maximally M+1, where M is received value of parameter MAX_RETRANS for a particular priority, attempts to send a PACKET CHANNEL REQUEST (or EGPRS PACKET CHANNEL REQUEST) message. After sending each PACKET CHANNEL REQUEST (or EGPRS PACKET CHANNEL REQUEST) message, the mobile station shall listen to the full PCCCH (corresponding to its PCCCH_GROUP).

The mobile station shall start timer T3186 at the beginning of the Packet Access Procedure. At expiry of timer T3186, the packet access procedure shall be aborted, packet access failure shall be indicated to upper layers and the mobile station shall return to packet idle mode. The first attempt to send a PACKET CHANNEL REQUEST (or EGPRS PACKET CHANNEL REQUEST) message, may be initiated at the first available PRACH block on the PDCH defined by the PCCCH_GROUP for the mobile station. The mobile station shall choose one of the four TDMA frames within the selected PRACH block randomly with a uniform probability distribution. For each attempt, the mobile station shall draw a random value R with uniform probability distribution in the set {0, 1, . . . 15}. The mobile station is allowed to transmit a PACKET CHANNEL REQUEST message if P(i), where i is the radio priority of the TBF being established, is less or equal to R. After each attempt, the S and T parameters are used to determine the next TDMA frame in which it may be allowed to make a successive attempt. The number of TDMA frames belonging to the PRACH on the PDCH defined by the PCCCH_GROUP for the mobile station between two successive attempts to send a PACKET CHANNEL REQUEST (or EGPRS PACKET CHANNEL REQUEST) message excluding the TDMA frames potentially containing the messages themselves is a random value drawn for each transmission with uniform probability distribution in the set {S, S+1, . . . , S+T−1}. Paragraph 8.1.2.5 describes uplink TBF establishment during downlink RLC data block transfer. The mobile station may request establishment of an uplink transfer during a downlink TBF by including a Channel Request Description information element in the PACKET DOWNLINK ACK/NACK message. Initiation is triggered by a request from upper layers to transfer a LLC PDU. The request from upper layers specifies a Radio Priority to be associated with the packet transfer. Upon such a request,
if access to the network is allowed, the mobile station initiates the packet access procedure.
otherwise, the RR sub-layer in the mobile station rejects the request.

The mobile station initiates the packet access procedure by sending the Channel Request Description information element in a PACKET DOWNLINK ACK/NACK message on the PACCH and starting a timer.

3GPP TS 44.060 describes an alternative to the procedure in specifications 3GPP TS 04.08 and 3GPP TS 04.60.

3^{rd} Generation Partnership Project (3GPP): Technical Specification Group GSM/EDGE Radio Access Network, General Packet Radio Service (GPRS), Mobile Station (MS)—Base Station System (BSS) interface, Radio Link Control/Medium Access Control (RLC/MAC) protocol (Release 5), 3GPP TS 44.060 v5.13.0, France, September 2004, specifies procedures for Radio Link Control, RLC, layer and Medium Access Control, MAC, layer, including physical link control functions of the radio interface between GSM/EDGE Radio Access Network, GERAN, and Mobile Station, MS. An Uplink State Flag, USF, is used on Packet Data Channel(s), PDCH(es) to allow multiplexing of uplink radio blocks from different mobile stations. An RR (Radio Resource) connection is a physical connection established between a mobile station and the network to support exchange of information flows. A TBF (Temporary Block Flow) is, in A/Gb mode, a physical connection used by the two RR peer entities to support the unidirectional transfer of LLC (Logical Link Control) PDUs on packet data physical channels. (A/Gb mode is a mode of operation of the MS when connected to the Core Network, CN, via GERAN and the A and/or Gb interfaces; the A interface being the interface between a BSS (Base Station Subsystem) and a 2G MSC (Mobile Switching Center) and the Gb interface being the interface between a BSS and a 2G SGSN (Serving GPRS Support Node).) In Iu mode, a TBF is a logical connection offered by two MAC entities to support the unidirectional transfer of RLC PDUs on basic physical sub-channels. (Iu mode is a mode of operation of the MS when connected to the CN via GERAN or UTRAN and the Iu interface; the Iu interface being the interface between a BSS or an RNC (Radio Network Controller) and a 3G MSC or a 3G SGSN.) In extended uplink TBF mode, the uplink TBF may be maintained during temporary inactive periods, where the mobile station has no RLC information to send.

The mobile station shall initiate a packet access procedure by scheduling sending of PACKET CHANNEL REQUEST messages on PRACH (Packet Random Access Channel) corresponding to its PCCCH_GROUP (Packet Common Control Channel Group) and simultaneously leaving the packet idle mode. While waiting for a response to the PACKET CHANNEL REQUEST message, the mobile station shall monitor the full PCCCH (Packet Common Control Channel) corresponding to its PCCCH_GROUP. While monitoring the full PCCCH, the mobile station shall decode any occurrence of the PERSISTENCE_LEVEL parameter included in a message received on PCCCH. When the mobile station receives the PERSISTENCE_LEVEL parameter, the value of the PERSISTENCE_LEVEL parameter shall be taken into account at the next PACKET CHANNEL REQUEST attempt that follows. The parameter PERSISTENCE_LEVEL comprises a persistence level P(i) for each radio priority i (i=1, 2, 3, 4); where P(i)ε{0, 1, . . . 14, 16}. The first attempt to send a PACKET CHANNEL REQUEST (or EGPRS PACKET CHANNEL REQUEST) message, may be initiated at the first available PRACH block on the PDCH (Packet Data Channel) defined by the PCCCH_GROUP for the mobile station. The mobile station shall choose one of four TDMA frames within the selected PRACH block randomly with a uniform probability distribution. For each attempt, the mobile station shall draw a random value R with uniform probability distribution in the set {0, 1, . . . 15}. The mobile station is allowed to transmit a PACKET CHANNEL REQUEST message provided that P(i) is less than or equal to R. Consequently, the smaller P(i), the greater is the persistency.

The mobile station generally operates with a sliding trans-mission window of RLC data PDUs. In the extended uplink TBF mode of Technical Specification 3GPP TS 44.060, if there is no RLC data block available within the window, the mobile station shall stop sending RLC data blocks. The mobile station shall continue sending RLC data blocks when an RLC data block becomes available in the window.

A UMTS correspondence of TBFs in GSM/GPRS and GSM/EGPRS are RABs (Radio Access Bearers).

3^{rd} Generation Partnership Project (3GPP): Technical Specification Group GSM/EDGE Radio Access Network, Multiplexing and multiple access on the radio path (Release 5), 3GPP TS 45.002 v5.12.0, France, April 2004, defines the physical channels of the radio sub system required to support the logical channels. It includes a description of the logical channels and the definition of frequency hopping, TDMA (Time Division Multiple Access) frames, time-slots and bursts. In the uplink part for channels other than PACCH (Packet Associated Control Channel) transmitted as access bursts on PRACH (Packet Random Access Channel) or CPRACH (Compact Packet Random Access Channel), the logical channel type shall be indicated by the message type contained in the block header part. For PACCH transmitted as access bursts, the logical channel type is indicated by the corresponding polling message on the downlink. For the PRACH or CPRACH case the logical channel type is indicated by the USF, set on the downlink on a block-by-block basis.

The MAC layer is responsible for sharing of communications resource (the air interface) common to data and voice users, according to an allocation strategy.

In e.g. GSM/GPRS, MAC of BSS (Base Station Subsystem) is responsible for management of uplink and downlink scheduling of RLC blocks belonging to different TBFs over available time slots, resolving conflicts due to e.g. request collisions, assigning uplink TBFs to requesting MTs (Mobile Terminals) if there are time-slots available, notifying of uplink TBF deallocation if MT has been inactive during a predefined period, associating respective voice calls to a pair of time-slots and signaling as need be for deallocating of a TBF to render the time-slot pair available for speech communications. In uplink direction, MAC of MT is responsible for initiating transmission of requests of uplink TBFs to BSS for transfer of data for which no TBF is yet established. Once the TBF setup is acknowledged, MAC of MT forwards RLC PDUs, carrying one or more segmented LLC PDUs, over a time-slot allocated by BSS. MT continues sending until there is no more data to send, or it has transmitted a maximum number of RLC blocks allowed. The TBF is then released. Each TBF is assigned by the network a temporary flow identity, TFI, which is unique in both directions.

FIG. 2 illustrates schematically segmentation/reassembly of LLC PDUs and RLC PDUs. The LLC PDU comprises a frame header <<FH>>, LLC data or control information <<Information field>>, and a frame check sequence <<FCS>>. A radio block consists of a 1-byte MAC header <<BH>> followed by RLC data <<Info field>>, or an RLC/MAC control block <<Info field>>, finalized by a 16-bit block check sequence, <<BCS>>. The radio block is carried on the physical channel by four normal bursts.

None of the cited documents above discloses scheduling of uplink packet data transmissions or uplink TBF establishment triggered by downlink session ending, unconditioned on whether the related user or user equipment has data to send or not.

### SUMMARY OF THE INVENTION

A general problem of multiple access systems is to fulfill various requirements of a session as regards, e.g. QoS. Another problem is how to incorporate such requirements when allocating traffic to communications resources and scheduling of transmission instances.

In multi-user access, delay or latency is often of vital importance. The demand for short delay or low latencies are immediate when real-time applications, e.g. speech, are provided over packet switched connections. One such example application is Push-to-talk over Cellular, PoC.

Generally, this is particularly a problem in uplink direction when a user e.g. does not get any response of a button press until after a delay, or cannot get his voice message through during a conversation despite the other party has stopped talking waiting for a response. Remembering that in typical existing systems, it is the network side of a wireless connection that is responsible for the TBF establishment in GSM/GPRS or GSM/EGPRS, RAB establishment in UMTS and correspondingly in CDMA2000, the delayed establishment is less of a problem in downlink direction, where a base station transmits data to a plurality of users and resources efficiently can be allocated and scheduled in relation to information available at sender side (without propagation time delay to a wireless user equipment).

In uplink direction a base station receiving information from a plurality of user devices, the queue status of the mobile entity is not always available, at least not if limited time restrictions also need to be met. Further it may not be efficient to spend communication resources on communicating such information to a scheduling entity, such as a base station, BS, or base station controller, BSC.

Consequently, there is a need of efficiently providing uplink communications channel scheduling and establishment of packet data transmissions for users, temporarily being in inactive state in terms of wireless transmissions, entering active state.

An object of the invention is to reduce time required for uplink communications channel establishment when user equipment or user enters an active state.

Another object is to provide signaling independent of amount of data in sender buffer for initiating uplink communications channel scheduling and uplink communications channel establishment.

It is also an object to provide a method and system of efficient scheduling and establishment uplink TBF, or correspondingly for the various communications systems.

A further object is to provide a method and system of uplink communications channel and establishment rendering PoC useful.

Finally, it is an object to provide a method and system of uplink communications channel and establishment integrating SIP signaling.

These objects are met by a method and system of uplink scheduling or uplink communications channel establishment and associated signaling.

### BRIEF DESCRIPTION OF THE DRAWINGS

FIG. 1 illustrates in principle a protocol stack with RTP, UDP and IP transport and network protocol layers carrying a multimedia application according to prior art.

FIG. 2 demonstrates schematically segmentation/reassembly of LLC PDUs and RLC PDUs according to prior art.

FIG. 3 illustrates schematically an example of equal share splitting and regular scheduling of a resource according to prior art.

FIG. 4 shows persistent transmission of USFs on the downlink for persistent scheduling according to the invention.

FIG. 5 illustrates a signaling diagram according to the invention.

FIG. 6 illustrates a block diagram of an apparatus according to a first embodiment of the invention.

FIG. 7 illustrates a block diagram of an apparatus according to a second embodiment of the invention.

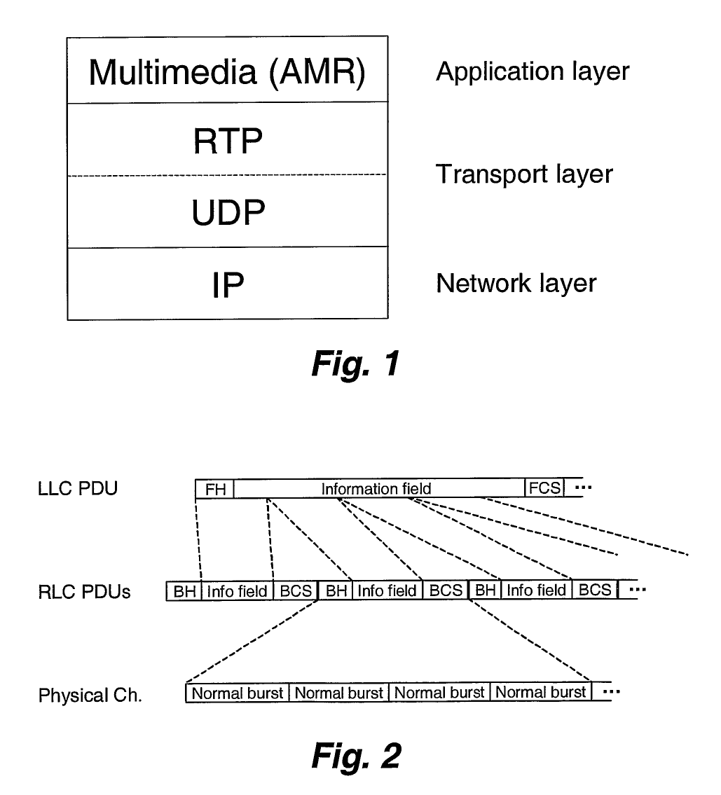

### DESCRIPTION OF PREFERRED EMBODIMENTS

For delay sensitive applications it is important with low latency.

In multi-user access, delay or latency is often of vital importance. The demand for short delay or low latencies are immediate when real-time applications, e.g. speech, are provided over packet switched connections. One such example application is Push-to-talk over Cellular, PoC.

The invention identifies that for many applications scheduling of one or more temporarily inactive TBFs (temporarily carrying no data) initiated conditioned on downlink session ending, unconditioned on whether the related user or user equipment has data to send or not reduces delay and latency. If a user equipment or user does not utilize the established TBF (s), the TBF (s) are released according to release criteria, known in the art.

To further reduce delay and latency, according to the invention the transmission scheduling is preferably persistent. USF flags are then sent more frequently than with regular transmission scheduling, this increases the requirements on the mobile station to actively being capable of receiving the scheduling information, thereby to some extent increasing power consumption as compared to a case when the invention is applied with less preferred regular non-persistent scheduling, even if optimized. An advantage achieved is that an entity of user equipment or a user then can send a greater number of blocks at once, without having to wait for potentially other entities of user equipment.

Generally, the delayed uplink TBF establishment of prior art is particularly a problem in uplink direction. In downlink direction, a base station transmits data to a plurality of users and resources can efficiently be allocated and scheduled in relation to information available at sender side (without propagation time delay to a wireless user equipment).

A problem in prior art is also that in uplink direction, the queue status of the mobile entity is not always available to a base station receiving information from a plurality of user devices, at least not if limited time restrictions also need to be met. Further it may not be efficient to spend communication resources on communicating such information to a scheduling entity, such as a base station or base station controller.

When a user equipment or user becomes inactive, not transmitting data but possibly receiving data, an earlier established TBF for the transmission of data is released unless new data arrives during a time frame in order of seconds. If the user equipment or user becomes active after this time frame and data then arrives, the TBF needs be established anew. The establishment takes time. It is identified that delay can be reduced by approximately 0.2 s by TBF establishment and scheduling according to the invention. With two parties involved in a conversation over similar connections the perceived effect is doubled. The effect is clearly noticeable. This is particularly the case, e.g., for speech communication in PoC and when web-browsing over cellular.

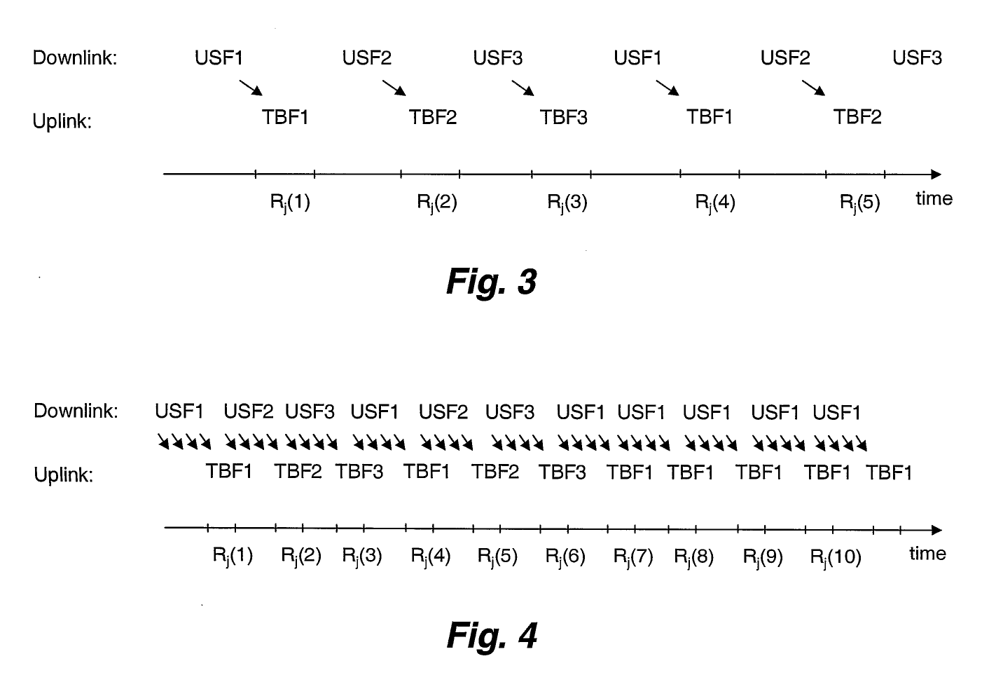

An example of equal share splitting and regular scheduling of a resource is schematically illustrated in FIG. 3. In the example there are three uplink TBFs <<TBF1>>, <<TBF2>>, <<TBF3>> scheduled for a communications resource Rⱼ(t) at various time instances t <<Rⱼ(1)>>, <<Rⱼ(2)>>, <<Rⱼ(3)>>, <<Rⱼ(4)>>, <<Rⱼ(5)>>. The communications resource can be, e.g., one or more recurring time slots of a time multiplexed system, which is anticipated in the figure. Each TBF is preceded by a corresponding USF <<USF1>>, <<USF2>>, <<USF3>>.

In regular scheduling, such as the scheduling illustrated in FIG. 3, USFs are typically transmitted separated in time not less than 20 ms.

FIG. 4 shows persistent transmission of USFs on the downlink for persistent scheduling according to the invention. Preferably, with persistent scheduling of TBFs according to the invention the resource is split in equal shares, as the TBF establishment is not based on amount of user data to send. However, if the base station serves only one entity of user equipment operating according to the invention, the share scheduled is increased for this user. This is illustrated in the figure by scheduling of a TBF <<TBF1>> for a plurality of consecutive time instances <<Rⱼ(7)>>, <<Rⱼ(8)>>, <<Rⱼ(9)>>, <<Rⱼ(10)>> or scheduling for a more frequent resource allocation of one or more particular TBFs than scheduling with equal share splitting.

Uplink TBF scheduling and establishment could also be accomplished in accordance with the method and system described in International Patent Application No. PCT/SE2004/001592.

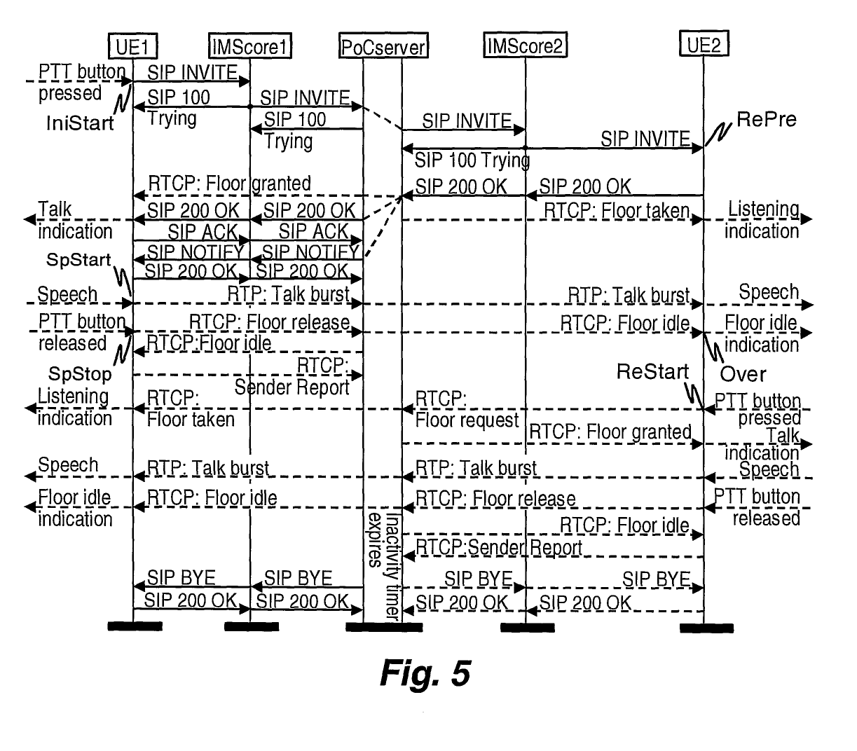

FIG. 5 illustrates a signaling diagram according to the invention. There are two entities of user equipment <UE1>>, <<UE2>>, information management services, IMS, core server <<IMScore1>>, <<IMScore2>> operating according to SIP, and a PoC server <<PoCserver>>. The first entity of user equipment <<UE1>> starts a PTT (Push To Talk) connection by, e.g., pressing a talk-button (PTT button pressed) on the handset <<IniStart>>. The signaling between the first entity of user equipment <<UE1>> and the PoC server <<PoCserver>>. The initial signaling following, until the first entity of user equipment <UE1>> starts sending speech information <<SpStart>>. When the user of the first entity of user equipment releases the talk-button and the entity stops sending speech information, at least temporarily <<SpStop>>, a floor release signal is sent to the PoC server <<PoCserver>>, which sends a floor idle signal to all parties, participating in the communication <<Over>>. A party taking the opportunity to respond <<ReStart>> presses the talk-button of his entity of user equipment <<UE2>>, whereby the user equipment UE2>> sends a floor request signal. The sending of the floor request signal requires an established uplink TBF available for the communication. If the foregoing speaker talked for a longer time (typically 1.5 s) than specified for release of inactive TBFs, and the second entity of user equipment <UE2>> was inactive in the meantime, the uplink TBF needs be established anew.

According to the invention, the uplink TBF is preferably established when a downlink dataflow finishes <<Over>>, at least temporarily, to reduce the perceived delay of the response. The uplink TBF scheduling and establishment of the second entity of user equipment UE2>> preferably corresponds to uplink TBF scheduling and establishment described for the first entity of user equipment <UE1>>, but is not included in the figure for reasons of clarity.

Toll quality of, e.g., PoC requires delay reduction. The invention provides such delay reduction. It will also improve e.g. web-browsing over cellular.

According to a first embodiment of the invention a base station controller or corresponding entity over which downlink data is routed to an entity of user equipment detects when a downlink data transfer is ended and a dataflow ends. Preferably, data transfers comprising more than a predefined number of data blocks, e.g. corresponding to floor idle burst size, are considered for triggering of uplink TBF establishment. According to the first embodiment of the invention, the TBF establishment does not require involvement of the user equipment to which the data transfer is destined for requesting TBF establishment. The BSC establishes the uplink TBF and sends USFs to the user equipment.

According to a second embodiment of the invention, an entity of user equipment detecting that a downlink data transfer is ended automatically, preferably not requiring user interaction, starts sending of dummy data in uplink direction, the dummy data filling the output buffer and thereby triggering TBF establishment. The session ending is preferably detected by monitoring of reception of a floor idle or corresponding signal.

When the invention is applied to establishment of one or more RABs of UMTS, establishment is preferably initiated by a received SIP_INVITE signal <<RePre>>, illustrated in the initial signaling received by <<UE2>> in FIG. 5.

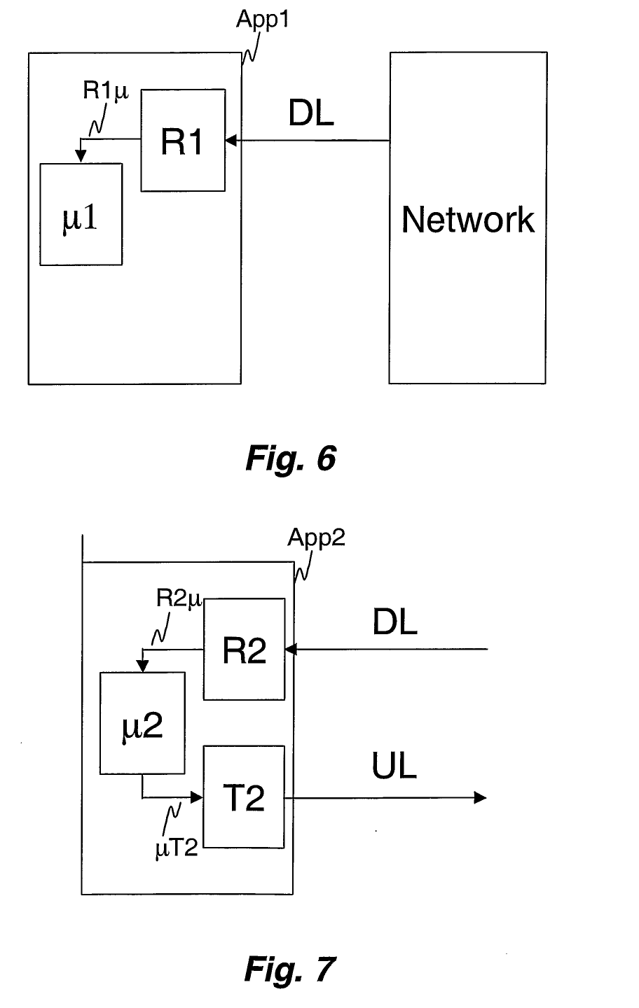

FIG. 6 illustrates a block diagram of an apparatus <<App1>> according to a first embodiment of the invention. Processing means <<μ1>> conditionally initiates one or more uplink <<UL>> TBFs, conditioned on ending of a downlink <<DL>> data communication session involving the apparatus. The ending of a downlink data communication session is preferably detected by monitoring downlink <<DL>> data received by the apparatus in receiving means <<R1>> from the network side <<Network>> and transferred <<R1μ>> to the processing means. Preferably the processing means are arranged for monitoring ending of transfer of downlink data communication transfer greater than a predefined number of data blocks, e.g. corresponding to the size of a floor idle burst. In a less preferred mode, processing means <<±1>> is arranged for monitoring of downlink signaling for a floor idle signal or corresponding signal and initiates uplink TBF establishment upon detection.

FIG. 7 illustrates a block diagram of an apparatus <<App2>> according to the second embodiment of the invention. Receiving means <<R2>> receives downlink data and signaling and transfers <<R2μ>> to processing means <<±2>>. The processing means conditionally initiates sending of dummy data initiating uplink TBF establishment. The initiating is preferably initiated when the processing means <<μ2>> detects a floor idle signal received by the apparatus <<R2>> on the downlink <<DL>>. In another mode of the second embodiment of the invention, the processing means <<μ2>> is arranged for monitoring ending of a downlink data transfer of a predefined number of data blocks, e.g. 500 blocks. Dummy data or signaling is transferred <<T2>> to transmitting means <<T2>> transmitting a packet channel request on the uplink.

In this patent application acronyms such as IP, UDP, RTP, SIP, TBF, RAB, BSS, MT, MS, GSM, GPRS, EGPRS, UMTS or CDMA2000 are applied. However, the invention is not limited to systems with entities with these acronyms, but holds for all communications systems operating analogously.

The invention is not intended to be limited only to the embodiments described in detail above. Changes and modifications may be made without departing from the invention. It covers all modifications within the scope of the following claims.

1. A method of wireless uplink packet data communications characterized in that ending of a downlink data communication session initiates establishment of one or more uplink communication channels.

2. The method according to claim 1 characterized in that a base station controller conditionally initiating establishment of one or more uplink communication channels when a downlink data transfer is ended.

3. The method according to claim 2 characterized in that establishment of one or more uplink communication channels is initiated by ending of downlink data transfer comprising more than a predefined number of data blocks.

4. The method according to claim 3 characterized in that the predefined number of data blocks corresponds to the size of a floor idle burst.

5. The method according to claim 1 characterized in that downlink signaling is monitored for detecting of a downlink session data flow ending.

6. The method according to claim 5 characterized in that the downlink signaling is monitored for detecting of a received floor idle signal.

7. The method according to claim 5 characterized in that the downlink signaling is SIP signaling.

8. The method according to claim 1 characterized in that a user equipment conditionally starts sending dummy data triggering establishment of one or more uplink communication channels.

9. The method according to claim 8 characterized in that a user equipment conditionally starts sending dummy data triggering establishment of one or more uplink communication channels when receiving a floor idle signal on the downlink.

10. The method according to claim 1 characterized in that the initiated establishment of one or more uplink communication channels comprises persistent scheduling.

11. The method according to claim 10 characterized in that the persistent scheduling of one or more communication channels involves sending of USFs concerning a particular TBF separated in time by less than 20 ms.

12. The method according to claim 1, characterized in that the one or more communications channels are one or more TBFs.

13. The method according to claim 12 characterized in that the downlink data communication session is part of a PoC session.

14. The method according to claim 1, characterized in that the downlink data communication session is part of a PoC session.

15. An apparatus of wireless uplink packet data communications characterized by processing means for conditionally initiating establishment of one or more uplink communication channels, conditioned on ending of a downlink data communication session involving the apparatus.

16. The apparatus according to claim 15 characterized in that the apparatus is included in or is a base station controller.

17. The apparatus according to claim 16 characterized in that the base station controller conditionally initiating establishment of one or more uplink communication channels when a downlink data transfer is ended.

18. The apparatus according to claim 17 characterized in that establishment of one or more uplink communication channels is initiated by ending of downlink data transfer comprising more than a predefined number of data blocks.

19. The method according to claim 18 characterized in that the predefined number of data blocks corresponds to the size of a floor idle burst.

20. The apparatus according to claim 17 characterized by processing means arranged for monitoring of downlink signaling for detecting of a downlink session data ending.

21. The apparatus according to claim 20 characterized in that the processing means are arranged for detecting a received floor idle signal.

22. The apparatus according to claim 20 characterized in that the downlink signaling is SIP signaling.

23. The apparatus according to claim 15 characterized in that the apparatus is included in or is an entity of user equipment.

24. The apparatus according to claim 23 characterized by processing means for conditionally initiating sending of dummy data triggering establishment of one or more uplink communication channels.

25. The apparatus according to claim 24 characterized by processing means monitoring downlink signaling and detector means for detecting a floor idle signal, the user equipment being arranged to conditionally start sending of dummy data triggering establishment of one or more uplink communication channels when receiving a floor idle signal on the downlink.

26. The apparatus according to claim 23 characterized by transmitting means for sending of dummy data conditionally initiated when the apparatus receives a floor idle signal on the downlink.

27. The apparatus according to claim 15 characterized in that the initiated establishment of one or more uplink communication channels comprises persistent scheduling.

28. The apparatus according to claim 27 characterized in that the persistent scheduling of one or more communication channels involves sending of USFs concerning a particular TBF separated in time by less than 20 ms.

29. The apparatus according to claim 15 characterized in that the one or more communications channels are one or more TBFs.

30. The apparatus according to claim 29 characterized in that the downlink data communication session is part of a PoC session.

31. The apparatus according to claim 15 characterized in that the downlink data communication session is part of a PoC session.

32. A communications system characterized by the communications system comprising processing means for carrying out the method in claim 1.

33. A communications system c characterized by the communications system comprising a plurality of apparatuses in claim 15.
